(19) United States
(12) Patent Application Publication
(10) Pub. No.: US 2008/0218633 A1
(43) Pub. Date: Sep. 11, 2008

(54) Method and System for Transmitting Video Signals

(75) Inventors: Fu-Chin Shen, Taipei Hsien (TW); Chia-Cheng Liu, Taipei Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei Hsien (TW)

(21) Appl. No.: 11/683,087

(22) Filed: Mar. 7, 2007

(51) Int. Cl. H04N 9/00

(52) U.S. Cl. 348/496; 375/240.28; 348/E11.007

(57) ABSTRACT

The first device receives the video signal to encode a horizontal sync signal and a vertical sync signal of the video signal into a composite sync signal, compresses the composite sync signal into one of three color signals of the video signal, and transmits the three color signals. The second device is in communication with the first device, decompresses the composite sync signal from the compressed color signal, and decodes the horizontal sync signal and the vertical sync signal from the composite sync signal. A method for transmitting video signals and a KVM device are also disclosed.

### BACKGROUND

1. Field of Invention

The present invention relates to the video signal transmission. More particularly, the present invention relates to a method and system for transmitting video signals with R, G, B, H and V signals.

2. Description of Related Art

FIG. 1 illustrates a conventional video extender 100, which is used to transmit video signals from a computer 112 to a monitor 114 via a cable 106. The video extender 100 includes a dongle device 102 and a console device 104 coupled to the computer 112 and the monitor 114, respectively. Generally, the video signal provided from the computer 112 contains a horizontal sync signal (H), a vertical sync signal (V), a red color signal (R), a green color signal (G) and a blue color signal (B), and the cable 106 connecting the dongle and console devices 102 and 104, such as a CAT. 5 cable, has three pairs of wires.

In order to transmit the five signals by the only three pairs of wires, the dongle device 102 of the conventional video extender 100 typically compresses (or mixes) the horizontal sync signal (H) and the vertical sync signal (V) into the blue color signal (B) and the green color signal (G), respectively, and the console device 104 then decompress (or extracts) the horizontal sync signal (H) and the vertical sync signal (V) from the two compressed color signals (H+B) and (V+G) after the cable 106.

By this conventional architecture, once the video signal provided from the computer originally contains a composite sync signal (H+V) into which the horizontal sync signal (H) and the vertical sync signal (V) are encoded and three color signals (R), (G) and (B), such as a video signal used in a sun workstation, the dongle device 102 has to firstly decode the horizontal and vertical sync signals from the composite sync signal (H+V), and then compress each of the two sync signals (H) and (V) into one of the three color signals (R), (G) and (B) for transmitting through the cable 106 as mentioned above.

### SUMMARY

According to one embodiment of the present invention, a method for transmitting a video signal is disclosed. Firstly, A horizontal sync signal and a vertical sync signal of the video signal are encoded into a composite sync signal. The composite sync signal is then compressed into one of three color signals of the video signal. The three color signals, including the compressed color signal, are transmitted. After the transmitting, the composite sync signal is decompressed from the compressed color signal. Next, the horizontal sync signal and the vertical sync signal are decoded from the composite sync signal.

According to another embodiment of the present invention, a system for transmitting a video signal comprises a first device and a second device. The first device receives the video signal to encode a horizontal sync signal and a vertical sync signal of the video signal into a composite sync signal, compresses the composite sync signal into one of three color signals of the video signal, and transmits the three color signals. The second device is in communication with the first device, decompresses the composite sync signal from the compressed color signal, and decodes the horizontal sync signal and the vertical sync signal from the composite sync signal.

According to another embodiment of the present invention, a KVM device comprises at least one dongle device and at least one console device. The dongle device receives a video signal from a computer device, and the console device is in communication with the dongle device. The dongle device is arranged to encode a horizontal sync signal and a vertical sync signal of the video signal into a composite sync signal, compress the composite sync signal into one of three color signals of the video signal, and transmit the three color signals to the console device. The console device is arranged to decompress the composite sync signal from the compressed color signal, decode the horizontal sync signal and the vertical sync signal from the composite sync signal, and transmit the horizontal sync signal and the vertical sync signal to a monitor.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 illustrates a conventional video extender;

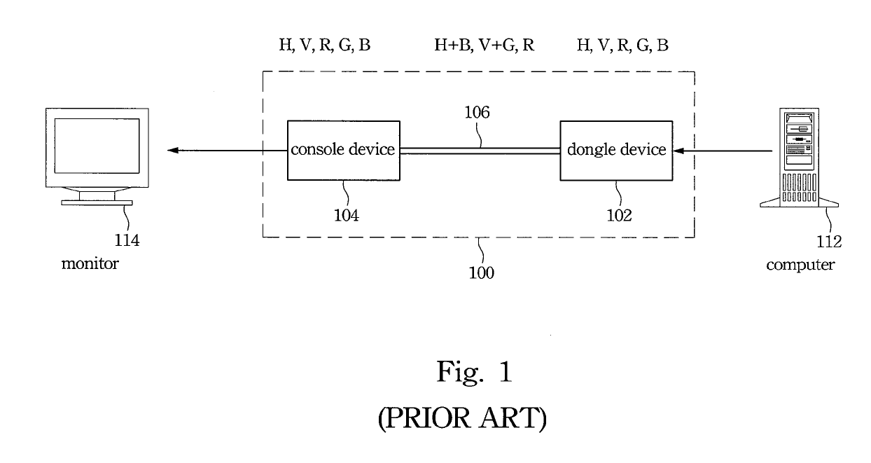

FIG. 2 is a flow chart of the method according to one example consistent with the present invention;

FIG. 3 is a system for transmitting video signals according to one example consistent with the present invention;

FIG. 4 is a KVM device according to another example consistent with the present invention; and

FIG. 5 illustrates the compressed signals according one example consistent with the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

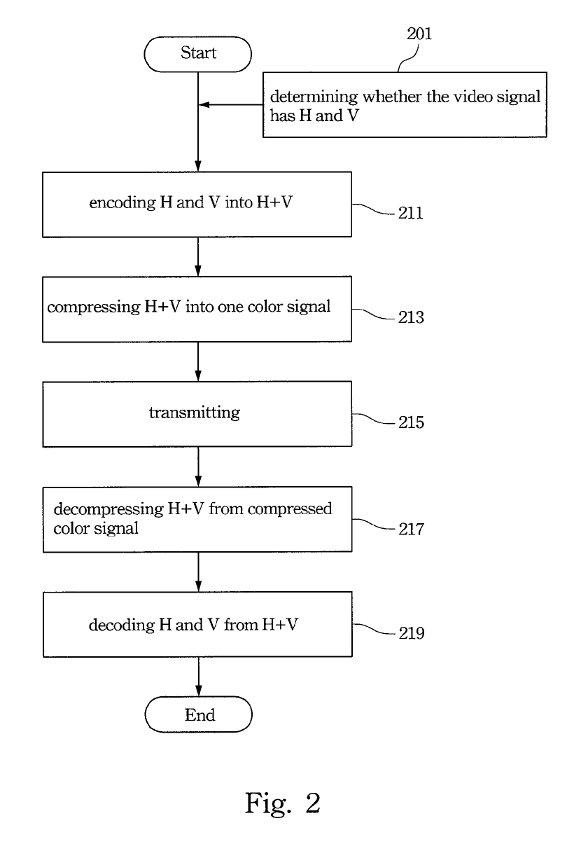

FIG. 2 is a flow chart of the method according to one example consistent with the present invention. Firstly, A horizontal sync signal (H) and a vertical sync signal (V) of a video signal are encoded into a composite sync signal (H+V) (step 211). The composite sync signal (H+V) is then compressed into one of three color signals of the video signal (step 213). The three color signals, including the compressed color signal, are transmitted via a cable (step 215) or even wirelessly. After the transmitting, the composite sync signal (H+V) is decompressed from the compressed color signal (step 217). Next, the horizontal sync signal (H) and the vertical sync signal (V) are decoded from the composite sync signal (H+V) (step 219).

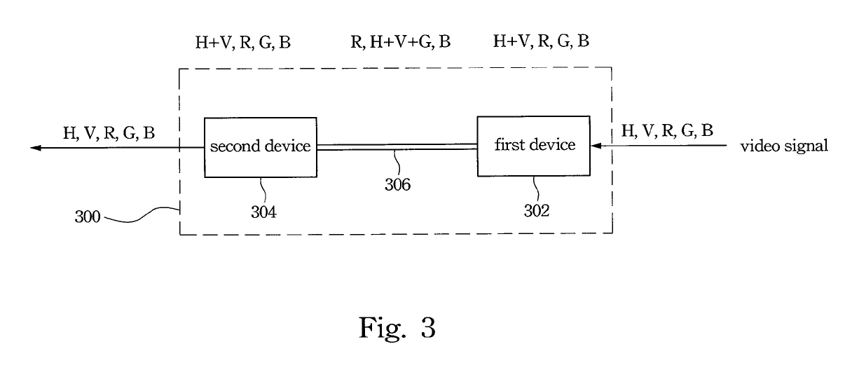

FIG. 3 is a system for transmitting video signals 300 according to one embodiment of the present invention. The system for transmitting video signals 300 includes, a first device 302 and a second device 304. The first device 302 receives the video signal, for example, from a computer device, to encode a horizontal sync signal (H) and a vertical sync signal (V) of the video signal into a composite sync signal (H+V), and compresses the composite sync signal (H+V) into one of three color signals (R), (G) and (B) of the video signal, thus obtaining a compressed color signal (H+V+G). It is noted that the composite sync signal (H+V) encoded by the first device 302 can be compressed into any of the three color signals, whether the red, green, or blue color signal, which is not limited by this example as illustrated in FIG. 3.

The first device 302 then transmits the three color signals (including the compressed color signal) (R), (H+V+G) and (B), via the cable 306, or an optical fiber, or even wirelessly. The second device 304 is in communication with the first device 302, may via the cable 306. The second device 304 decompresses the composite sync signal (H+V) from the compressed color signal (H+V+G), and decodes the horizontal sync signal (H) and the vertical sync signal (V) from the composite sync signal (H+V), for outputting to a monitor, for example.

The following description is made with reference to FIG. 2 and FIG. 3. In the examples, the first device 302 can determine whether the video signal has the horizontal sync signal (H) and the vertical sync signal (V) before performing the encoding of step 211 (step 201). That is, if the video signal input into the first device 302 is provided from the sun workstation, which originally contains the composite sync signal (H+V) instead of two independent sync signals (H) and (V), the first device 302 can recognize it and thus directly perform the next step 213.

In the example, the cable 306 generally has at least three pairs of wires, and each of the three color signals (R), (G) and (B) of the video signal are transmitted by one of the three pairs of wires, respectively. According to the embodiments, the cable 306 can be a CAT. 5 cable, a CAT. 5e cable, a CAT. 6 cable, a CAT. 6a cable or a CAT. 7 cable, which is available for transmitting video signals in the art.

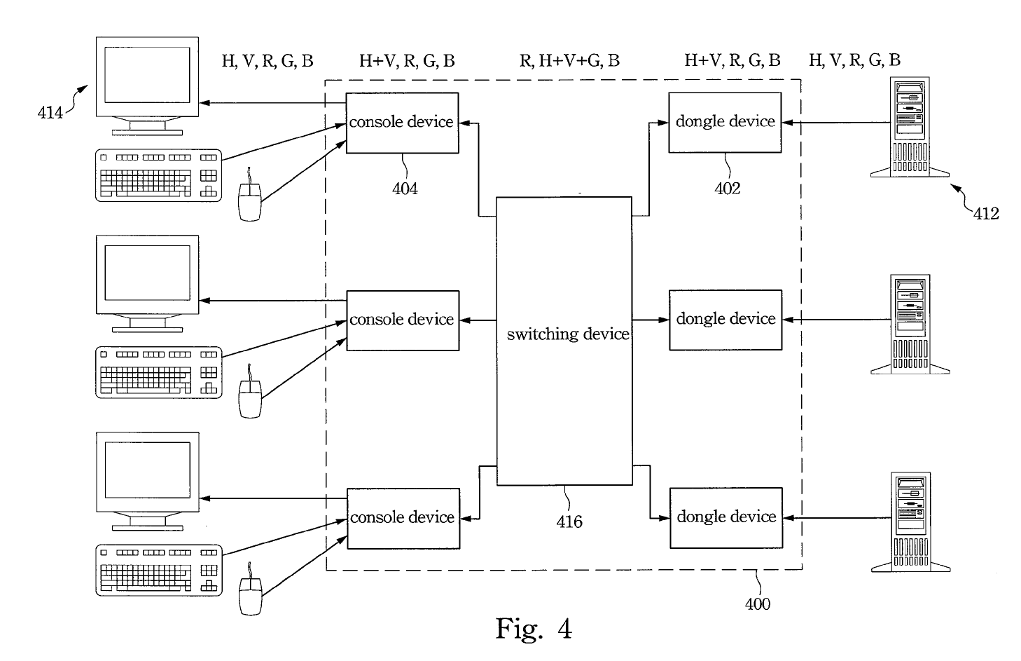

FIG. 4 is a KVM device 400 according to another example consistent with the present invention. The KVM device 400 includes at least one dongle device 402 and at least one console device 404. The dongle device 402 receives a video signal, which may be provided from a computer device 412, and the console device 404 is in communication with the dongle device 402, for example, via a cable or even wirelessly. The dongle device 402 is arranged to encode a horizontal sync signal (H) and a vertical sync signal (V) of the video signal into a composite sync signal (H+V), and then compress the composite sync signal (H+V into one of three color signals of the video signal (R), (G) and (B), thus obtaining a compressed color signal (H+V+G). It is noted that the composite sync signal (H+V) encoded by the dongle device 402 can be compressed into any of the three color signals, whether the red, green, or blue color signal, which is not limited by this example as illustrated in FIG. 4.

Next, the three color signals (R), (H+V+G) and (B) are transmitted to the console device 404, via the cable for example. The console device 404 is arranged to decompress the composite sync signal (H+V) from the compressed color signal (H+V+G), decode the horizontal sync signal (H) and the vertical sync signal (V) from the composite sync signal (H+V), and transmit the horizontal sync signal (H) and the vertical sync signal (V) to a monitor 414 coupled to the console device 404.

In the embodiment, the dongle device 402 can further determine whether the video signal has the horizontal sync signal (H) and the vertical sync signal (V) before encoding the composite sync signal (H+V). That is, if the computer device 412 is a sun workstation, by which the video signal provided originally contains the composite sync signal (H+V) instead of two independent sync signals (H) and (V), the dongle device 402 can recognize it and thus directly perform the compressing step.

In the example, the cable connected between the dongle device 402 and the console device 404 generally has at least three pairs of wires, and each of the three color signals (R), (G) and (B) of the video signal are transmitted by one of the three pairs of wires, respectively. According to the examples, the cable can be a CAT. 5 cable, a CAT. 5e cable, a CAT. 6 cable, a CAT. 6a cable or a CAT. 7 cable, which is available for transmitting video signals in the art.

The KVM device 400 can be a KVM extender, which allows a user located near the console device 404 to access the computer 412 coupled to the dongle device 402 such that the user and the computer 412 can be separate from each other, while including the dongle and console devices 402 and 404. In another aspect, the KVM device 400 can be a KVM switch, which allows users to access computers 412 by routing their communication paths, while including a switching device 416 in addition to more than one dongle and console devices 402 and 404.

More particularly, the switching device 416 is used to route communication paths among the dongle and console devices 402 and 404, such as the transmission of video signals. In this case, each of the console devices 404 couples to a keyboard and a mouse as well as the monitor 414. The dongle devices 402, the console devices 404 and the switching device 416 are connected via the cable as mentioned above. The compressed color signal (H+V+G) and the other two color signals (R) and (B) are inputted into the switching device 416 from the dongle device 402 and then outputted into the console device 404 from the switching device 416, both via the cables.

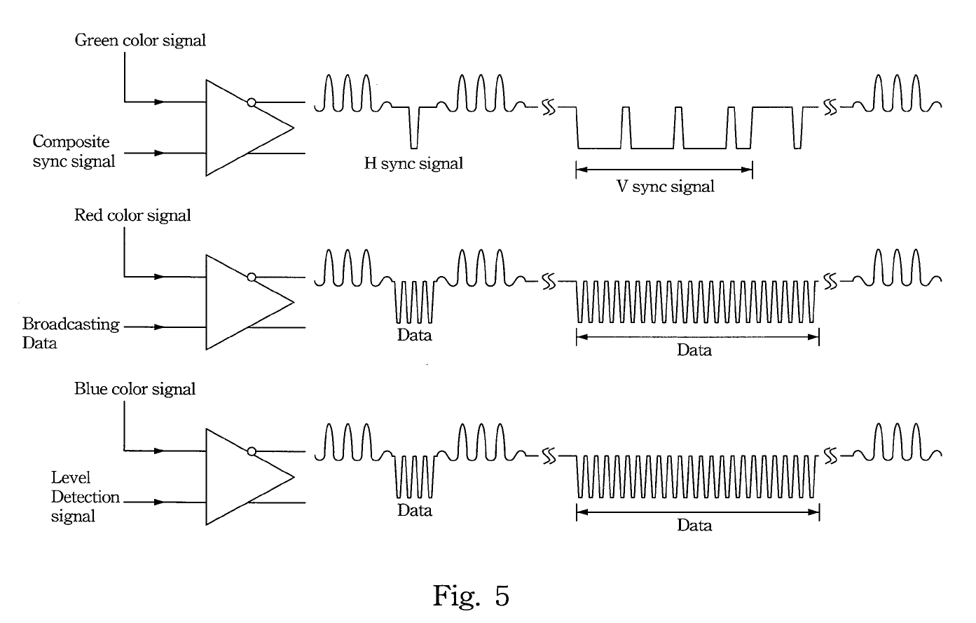

FIG. 5 illustrates the compressed signals according one example consistent with the present invention, which can be performed by the first device 302 or the dongle device 402. Besides the composite sync signal compressed into the green color signal (G), the other color signals (R) and (B) also can be compressed with other functional signals, respectively. As illustrated in FIG. 5, a broadcasting data, such as an audio signal, is compressed into the red color signals (R), and a level detection signal, for example, used for the cable length detection, is compressed into the blue color signals.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for transmitting a video signal, comprising the steps of:
encoding a horizontal sync signal and a vertical sync signal of the video signal into a composite sync signal;
compressing the composite sync signal into one of three color signals of the video signal;
transmitting the three color signals;
decompressing the composite sync signal from the compressed color signal; and
decoding the horizontal sync signal and the vertical sync signal from the composite sync signal.

2. The method for transmitting a video signal as claimed in claim 1, further comprising:
determining whether the video signal has the horizontal sync signal and the vertical sync signal before the encoding step.

3. The method for transmitting a video signal as claimed in claim 1, wherein the three color signals are transmitted via a cable which comprises at least three pairs of wires, and the three color signals are transmitted by the three pairs of wires, respectively.

4. The method for transmitting a video signal as claimed in claim 3, wherein the cable is selected from the group consisting of a CAT. 5 cable, a CAT. 5e cable, a CAT. 6 cable, a CAT. 6a cable and a CAT. 7 cable.

5. The method for transmitting a video signal as claimed in claim 1, wherein the encoding and compressing steps are performed by a first device, the decompressing and decoding steps are performed by a second device, and the first device is in communication with the second device.

6. The method for transmitting a video signal as claimed in claim 5, wherein the first device is a dongle, and the second device is a console.

7. The method for transmitting a video signal as claimed in claim 5, further comprising:
routing a path between the first and second devices before the transmitting step.

8. A system for transmitting a video signal, comprising:
a first device receiving the video signal to encode a horizontal sync signal and a vertical sync signal of the video signal into a composite sync signal, and compressing the composite sync signal into one of three color signals of the video signal; and
a second device in communication with the first device, decompressing the composite sync signal from the compressed color signal, and decoding the horizontal sync signal and the vertical sync signal from the composite sync signal.

9. The system for transmitting a video signal as claimed in claim 8, wherein the first device further determines whether the video signal has the horizontal sync signal and the vertical sync signal before the encoding step.

10. The system for transmitting a video signal as claimed in claim 8, wherein the three color signals are transmitted via a cable which comprises at least three pairs of wires, and the three color signals are transmitted by the three pairs of wires, respectively.

11. The system for transmitting a video signal as claimed in claim 10, wherein the cable is selected from the group consisting of a CAT. 5 cable, a CAT. 5e cable, a CAT. 6 cable, a CAT. 6a cable and a CAT. 7 cable.

12. The system for transmitting a video signal as claimed in claim 8, wherein the first device is a dongle device, and the second device is a console device.

13. The system for transmitting a video signal as claimed in claim 8, further comprising:
a switching device routing a path between the first and second devices.

14. A KVM device, comprising:
at least one dongle device receiving a video signal from a computer device, wherein the dongle device is arranged to encode a horizontal sync signal and a vertical sync signal of the video signal into a composite sync signal, and compress the composite sync signal into one of three color signals of the video signal; and
at least one console device in communication with the dongle device, wherein the console device is arranged to decompress the composite sync signal from the compressed color signal, decode the horizontal sync signal and the vertical sync signal from the composite sync signal, and transmit the horizontal sync signal and the vertical sync signal to a monitor.

15. The KVM device claimed in claim 14, wherein the dongle device further determines whether the video signal has the horizontal sync signal and the vertical sync signal before the encoding step.

16. The KVM device as claimed in claim 14, further comprising:
a switching device routing communication paths among a plurality of the dongle and console devices.
